(19) United States
(12) Patent Application Publication
(10) Pub. No.: US 2024/0288875 A1
(43) Pub. Date: Aug. 29, 2024

(54) Control method and control system for unmanned aerial vehicle

(71) Applicant: ARASHI VISION INC., Shenzhen (CN)

(72) Inventors: Jingkang Liu, Shenzhen (CN); Wenjie Jiang, Shenzhen (CN); Yibin Guo, Shenzhen (CN); Shun Jia, Shenzhen (CN)

(21) Appl. No.: 18/566,138

(22) PCT Filed: May 23, 2022
(86) PCT No.: PCT/CN2022/094397

§ 371 Date: Dec. 1, 2023

(30) Foreign Application Priority Data
Jun. 2, 2021 (CN) 202110614978.7

(51) Int. Cl. G05D 1/224; H04N 23/68; H04N 23/698

(52) U.S. Cl. CPC G05D 1/2247; H04N 23/698; H04N 23/682

(57) ABSTRACT

A control method and a control system for an unmanned aerial vehicle, the control method comprising: S1, acquiring the attitude of an unmanned aerial vehicle and displaying the attitude; S2, acquiring a panoramic video around the unmanned aerial vehicle corresponding to the attitude; S3, displaying the panoramic video, according to viewing angle display; and S4, controlling the unmanned aerial vehicle to move, according to a received flight control command and returning to step S1.

### TECHNICAL FIELD OF THE INVENTION

The present application relates to the technical field of unmanned aerial vehicles, and in particular, relates to a control method and a control system for an unmanned aerial vehicle.

### BACKGROUND OF THE INVENTION

Unmanned aerial vehicle (UAV) has been widely used in surveillance and aerial photography nowadays, and operators can watch images or videos taken by photographing devices on the UAVs through remote display terminals (such as computers, mobile phones or VR helmets or the like) so as to obtain the viewing experience from the viewing angle of the UAV.

Most of the existing surveillance and aerial photography schemes for UAV are to mount a camera head in front of the UAV in the flight direction, and then send videos captured by the camera head to a remote display terminal for the UAV operators to watch, thereby realizing the flight experience from the viewing angle in the flight direction of the UAV.

### SUMMARY

In a first aspect, an embodiment of the present invention provides a control method for an unmanned aerial vehicle, which includes the following steps: S1: acquiring the attitude of an unmanned aerial vehicle and displaying the attitude; S2: acquiring a video around the unmanned aerial vehicle corresponding to the attitude; S3: displaying the video, according to a viewing angle display information; S4: controlling the unmanned aerial vehicle to move, according to a received flight control command, and returning to step S1; wherein the video includes spherical panoramic video, annular panoramic video or wide-angle video.

Optionally, the step S1 includes: S11: acquiring the attitude of the unmanned aerial vehicle in a world coordinate system; S12: constructing a display interface coordinate system; S13: converting the attitude of the unmanned aerial vehicle in the world coordinate system into the attitude in the display interface coordinate system and displaying the attitude in the display interface coordinate system.

Optionally, the step S3 includes the following steps: S31: acquiring viewing angle display information in the display interface coordinate system; S32: converting the viewing angle display information in the display interface coordinate system into viewing angle display information in the world coordinate system; S33: displaying the panoramic video according to the viewing angle display information in the world coordinate system.

Optionally, the attitude of the unmanned aerial vehicle described above includes a flight direction and/or coordinates of the unmanned aerial vehicle so that the course or state of the unmanned aerial vehicle is displayed on the display interface.

Optionally, the viewing angle display information described above includes a display direction, or includes the display direction and a size of viewing angle.

Optionally, in order to enable viewers to watch a smooth video at any angle and improve the visual experience of viewers, the panoramic video described above is a video processed by stabilizing technology.

In a second aspect, a control system for an unmanned aerial vehicle is provided which includes an unmanned aerial vehicle, a display device and a remote control device; wherein the unmanned aerial vehicle includes a flight control device and a photographing device, the flight control device is configured to acquire attitude information of the unmanned aerial vehicle, the photographing device is configured to acquire a video around the unmanned aerial vehicle; the display device is configured to display the attitude of the unmanned aerial vehicle and display the video according to a viewing angle display information; the remote control device is configured to send a flight control command to the flight control device, wherein the video includes spherical panoramic video, annular panoramic video or wide-angle video.

Optionally, the photographing device includes at least two lenses, and fields of view of adjacent lenses among the at least two lenses overlap each other to form a 360-degree panoramic viewing angle around the unmanned aerial vehicle.

Optionally, the photographing device is a panoramic camera, which is installed on the fuselage of the unmanned aerial vehicle to obtain the panoramic video around the unmanned aerial vehicle.

Optionally, the display device is VR glasses, which can not only display the attitude of the unmanned aerial vehicle, but also obtain the viewing angle display information according to the detected head movement, and display the video according to the viewing angle display information.

Optionally, the remote control device is a somatosensory remote controller, and a flight control command may be generated through the motion of the somatosensory remote controller in the three-dimensional space and then sent to the flight control device to control the flight of the unmanned aerial vehicle.

### BRIEF DESCRIPTION OF THE DRAWINGS

FIG. 1 is a flowchart diagram of a control method for an unmanned aerial vehicle in Embodiment 1 of the present invention.

FIG. 2 is a flowchart diagram of step S1 in FIG. 1.

FIG. 3 is a flowchart diagram of step S3 in FIG. 1.

FIG. 4 is a schematic view showing the corresponding angle of a panoramic video on a flat-paneled display screen.

FIG. 5 is a schematic view of the display interface of the unmanned aerial vehicle when flying in the direction of the viewer.

FIG. 6 is a schematic view of the display interface when the unmanned aerial vehicle in FIG. 5 flies to the left.

FIG. 7 is a schematic view of a control system for an unmanned aerial vehicle in Embodiment 2 of the present invention.

### DETAILED DESCRIPTION

In order to make objectives, technical solutions and beneficial effects of the present invention more clear, the present invention will be further illustrated in detail with reference to attached drawings and embodiments. It shall be appreciated that the specific embodiments described here are only used to explain the present invention, and are not intended to limit the present invention.

The control methods for the unmanned aerial vehicles described above have the following defects.
1. Due to limitation by the orientation and shooting range of the camera head, only images or videos within a certain viewing angle in front of the unmanned aerial vehicle can be seen. For example, when the operator of the unmanned aerial vehicle needs to continuously observe a video object of interest, it is required to control the unmanned aerial vehicle to turn or turn around in order to re-observe the video object of interest if the video object is no longer within the viewing angle of the camera head.
2. The video display direction is related to the flight direction of the unmanned aerial vehicle, and the direction of viewing angle for the user is consistent with the flight direction, which cannot be adjusted so that the user experience is poor.

In the technical solution of the present invention, the flight control is determined by the flight control command while the viewing angle display of the video is determined by the viewing angle display information, and thus the flight control and viewing angle display of the unmanned aerial vehicle are relatively independent from each other so that the viewing angle of the video around the unmanned aerial vehicle is not affected when the flight direction of the unmanned aerial vehicle is changed, thereby improving the video viewing experience of the viewer from the viewing angle of the unmanned aerial vehicle.

In order to illustrate the technical solutions of the present invention, the following description is made through specific embodiments.

### Embodiment 1

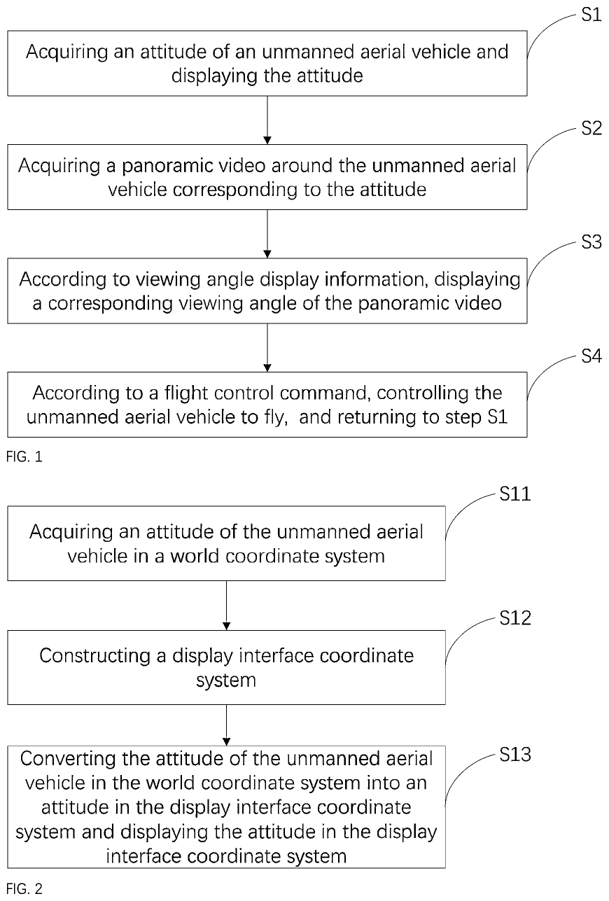

As shown in FIG. 1, a control method of an unmanned aerial vehicle in this embodiment includes the following steps.

S1: acquiring the attitude of the unmanned aerial vehicle and displaying the attitude.

In this embodiment, the attitude of the unmanned aerial vehicle at least includes the flight direction of the unmanned aerial vehicle or includes the flight direction and coordinates of the unmanned aerial vehicle, and then the attitude-related information is displayed through the display interface. The way in which the attitude is displayed is not limited, for example, the flight direction of the unmanned aerial vehicle is displayed on the display screen through arrows, cartoon images or reduced images of the unmanned aerial vehicle, and the coordinate information is displayed on the display screen through numbers and/or words. The flight direction of the unmanned aerial vehicle may be acquired by an inertial measurement unit (IMU), and the coordinates of the unmanned aerial vehicle may be acquired by a navigation system (e.g., GPS) of the unmanned aerial vehicle.

In an embodiment, as shown in FIG. 2, the step S1 includes the following sub-steps.

S11: acquiring the attitude of the unmanned aerial vehicle in the world coordinate system.

Specifically, the flight direction of the unmanned aerial vehicle in the world coordinate system can be obtained through the inertial measurement unit on the unmanned aerial vehicle, and the coordinates of the unmanned aerial vehicle in the world coordinate system can be obtained through the navigation system (e.g., GPS) of the unmanned aerial vehicle.

S12: constructing a display interface coordinate system.

A display interface coordinate system with the display interface as a reference is constructed. For example, the display interface coordinate system is constructed by taking the coordinates of the unmanned aerial vehicle in the world coordinate system as the origin and taking the actual flight direction of the unmanned aerial vehicle as the right forward direction.

S13: converting the attitude of the unmanned aerial vehicle in the world coordinate system into an attitude in the display interface coordinate system and displaying the attitude in the display interface coordinate system.

Firstly, the transformation matrix between the world coordinate system and the display interface coordinate system is calculated, then the coordinates in the display interface coordinate system are calculated by the transformation matrix and the coordinates of the unmanned aerial vehicle in the world coordinate system, and then the attitude of the unmanned aerial vehicle can be displayed in the display interface coordinate system in combination with the flight direction obtained by the inertial measurement unit (IMU).

S2: acquiring a video around the unmanned aerial vehicle corresponding to the attitude.

The video in this step includes spherical panoramic video, annular panoramic video or wide-angle video. The spherical panoramic video is a perspective spherical video formed with the unmanned aerial vehicle as the center of sphere. The annular panoramic video is a part of the spherical panoramic video, which can be obtained by clipping the spherical panoramic video. For example, the annular panoramic video can be formed by clipping a middle circle of the spherical video. The wide-angle video is a video shot by a wide-angle lens or a fisheye lens, whose viewing angle is more than 180 degrees but less than 360 degrees, and the wide-angle video may also be formed by splicing videos shot by multiple lenses.

Taking the spherical panoramic video as an example, no limitation is made to the way in which the spherical panoramic video around the unmanned aerial vehicle is obtained. For example, N lenses (N≥2) are arranged around the unmanned aerial vehicle, and the lenses may be distributed at any position around the fuselage of the unmanned aerial vehicle. The lenses are distributed such that a viewing angle range composed of the N lenses may include a viewing angle of 360 degrees around the unmanned aerial vehicle. That is, the fields of view of adjacent lenses overlap each other to form a 360-degree panoramic viewing angle around the unmanned aerial vehicle.

In this embodiment, after obtaining the spherical panoramic video, the spherical panoramic video may also be processed by the panoramic stabilizing technology to obtain a smooth video, so as to prevent the video from swaying up and down or from side to side due to the shaking of the unmanned aerial vehicle, thereby reducing the vertigo of the video viewer. The panoramic stabilizing technology can be implemented by adopting any stabilizing technology, such as physical stabilizing technology of three-axis tripod head, electronic stabilizing or algorithm stabilizing technologies or the like. Reference may be made to the relevant description in China Patent Publication No. CN107040694A for the electronic stabilizing or algorithm stabilizing technologies.

In an embodiment, two fisheye lenses are adopted which are respectively installed on two opposite sides of the fuselage of the unmanned aerial vehicle (the range of viewing angle of a single fisheye lens is greater than 180 degrees), and the combined viewing angle of the two fisheye lenses reaches 360 degrees. The two fisheye lenses are distributed as follows: the two fisheye lenses are distributed back-to-back on the upper and lower sides, front and rear sides and left and right sides of the fuselage, or distributed back-to-back on the upper or lower parts on the fuselage at the same side of the fuselage, and then the video frames shoot at the same time by the two fisheye lenses are integrated into spherical panoramic video frames, thereby obtaining the spherical panoramic video. The splicing of the spherical panoramic video belongs to the prior art, and reference may be made to the relevant description in China Patent Publication No. CN106023070A for details thereof.

In some other implementable schemes, the spherical panoramic video may also be shoot by a panoramic camera installed on the unmanned aerial vehicle.

S3: displaying the video, according to a viewing angle display information.

Taking the spherical panoramic video as an example, the viewing angle display information in this embodiment includes the display direction or the display direction and the size of viewing angle. The display direction is used to determine the direction of the spherical panoramic video to be displayed, and the size of viewing angle is used to display the size of the spherical panoramic video in this direction.

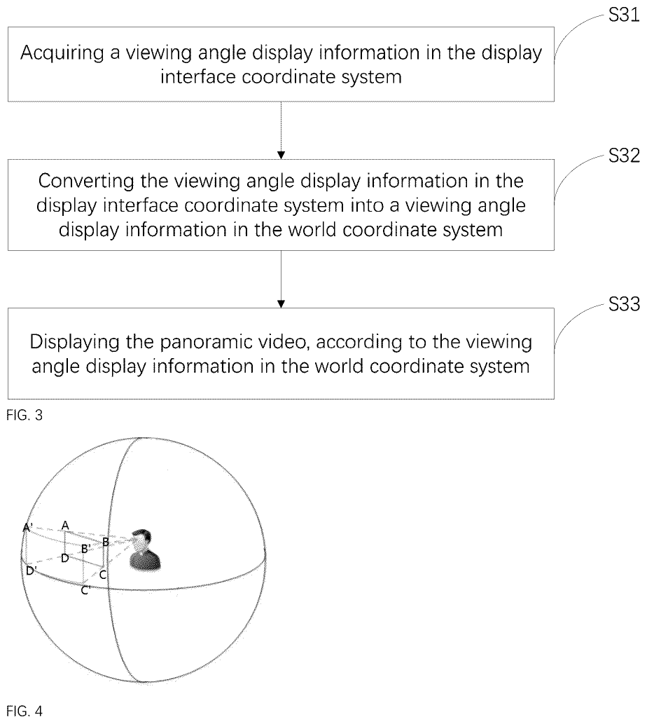

In an embodiment, as shown in FIG. 3, the step S3 includes the following sub-steps.

S31: acquiring viewing angle display information in the display interface coordinate system.

The display direction in the viewing angle display information may be obtained by detecting the head movement through a VR helmet, or by touching the display screen or moving the mouse or the like. For example, taking the case where the viewing angle display information is obtained through a VR helmet as an example, a sensor in the VR helmet detects the head movement and then converts it into the display direction of the viewing angle display information in the display interface coordinate system, and the size of viewing angle in the viewing angle display information is fixed (such as 120 degrees) or dynamically adjusted for example through VR glasses.

S32: converting the viewing angle display information in the display interface coordinate system into a viewing angle display information in the world coordinate system.

According to the transformation matrix between the world coordinate system and the display interface coordinate system, the viewing angle display information in the display interface coordinate system is converted into the viewing angle display information in the world coordinate system.

S33: displaying the video according to the viewing angle display information in the world coordinate system.

After the viewing angle display information is determined, the corresponding part of the spherical panoramic video can be displayed on the display interface of the display screen. As shown in FIG. 4, taking the case where a flat-panel display is used to display the spherical panoramic video as an example, when it is necessary to display the curved surface A′B′C′D′ in the spherical surface of spherical panoramic video after obtaining the viewing angle display information, the curved surface A′B′C′D′ may be projected into a flat image ABCD by projection to be displayed on the flat-panel display, that is, the picture at the corresponding angle of the spherical panoramic video is displayed on the flat-panel display.

S4: controlling the unmanned aerial vehicle to fly, according to a flight control command, and returning to step S1.

The flight control system of the unmanned aerial vehicle controls the unmanned aerial vehicle to perform the corresponding flight action by receiving the flight control command sent by the remote control device (such as the somatosensory remote controller). At this time, the attitude of the unmanned aerial vehicle has changed, and then the method returns to step S1.

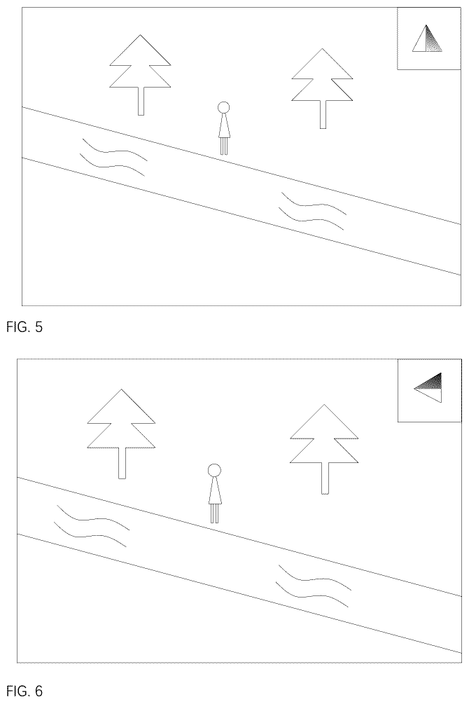

Referring to FIG. 5, FIG. 5 is a schematic view of the display interface seen by the viewer when the unmanned aerial vehicle flies in the direction of the viewer. The trees, rivers and people in the figure are a picture at the corresponding angle in the panoramic video, and the triangle icon in the upper right corner is the flight direction of the unmanned aerial vehicle (of course, the actual coordinate information, e.g., longitude, latitude, and height in the world coordinate system, of the unmanned aerial vehicle may also be added in the figure).

Referring to FIG. 6, FIG. 6 is a schematic view of the display interface seen by the viewer after the unmanned aerial vehicle receives a control command to fly to the left. Because the unmanned aerial vehicle has flied forward for a certain distance, the trees, rivers and people in FIG. 6 become larger than those in FIG. 5 in a basically smooth manner. At the same time, the direction of the triangle icon in the upper right corner has changed, which may remind the viewer of the current flight direction of the plane.

As can be known from the above description, the characteristics of the control method for the unmanned aerial vehicle according to the embodiments are as follow: a. the control command of the unmanned aerial vehicle and the viewing angle display information of the video around the unmanned aerial vehicle are independent from each other, that is, the operation of instructing the unmanned aerial vehicle to fly has no effect on viewing of the video around the unmanned aerial vehicle by the user; b. the attitude information of the unmanned aerial vehicle is updated in real time, and accordingly the video around the unmanned aerial vehicle is also updated in real time.

### Embodiment 2

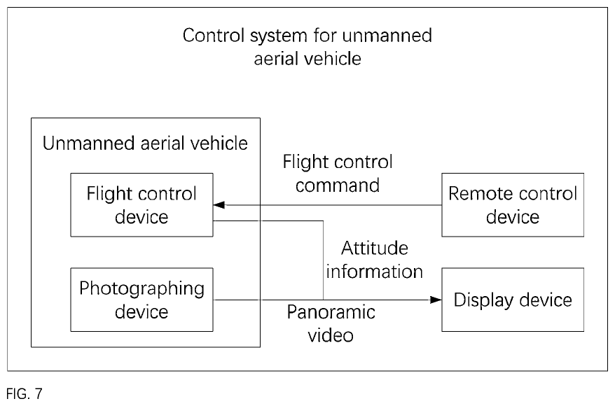

As shown in FIG. 7, a control system for the viewing angle of an unmanned aerial vehicle is disclosed in this embodiment, and the control system includes an unmanned aerial vehicle, a display device and a control device. The unmanned aerial vehicle includes a photographing device and a flight control device.

The photographing device is used for shooting videos and it includes a webcam and an image processing device. The videos shot by the photographing device include spherical panoramic video, annular panoramic video or wide-angle video, and reference may be made to description in Embodiment 1 for the definition of related videos. Taking the spherical panoramic video as an example, the webcam in this embodiment includes two fisheye lenses, which are respectively installed on the upper and lower sides of the fuselage of the unmanned aerial vehicle, each fisheye lens protrudes from the surface of the fuselage, and the fields of view of the two fisheye lenses form an annular and overlapped field of view around the fuselage, thereby forming a 360-degree panoramic field of view. The image processing device is used to splice the video frames shot by the lenses of the shooting device at the same time into panoramic video frames, thereby obtaining the spherical panoramic video. In this embodiment, the image processing device includes an image signal processor, and the image processing device may also be used for image processing such as automatic exposure, automatic gain control, gamma correction, white balance or the like. The image device may be installed on the unmanned aerial vehicle, the remote control device or the display device.

The flight control device is used to control the movement of the unmanned aerial vehicle. The flight control device in this embodiment includes an obstacle detection module, a flight module, a global positioning system (GPS), an inertial measurement unit (IMU) and a microprocessor (MCU). The obstacle detection module is used to detect obstacles around the unmanned aerial vehicle, including but not limited to detecting obstacles by visual sensors, laser radar, ultrasonic waves or the like. The flight module is used to enable the unmanned aerial vehicle to fly in the air. In this embodiment, the flight module includes four rotor wings, and each of the rotor wings includes a motor and blades driven by the motor to rotate. The global positioning system (GPS) is used to obtain the spatial position of the unmanned aerial vehicle (i.e., the coordinate position in the world coordinate system), the inertial measurement unit (IMU) is used to obtain the orientation of the unmanned aerial vehicle (i.e., the Euler angle of the unmanned aerial vehicle), and the microprocessor (MCU) is used to control the movement of the unmanned aerial vehicle according to the received control command sent by the remote control device and the received obstacle information detected by the obstacle detection device. In addition, as shall be known by those of ordinary skill in the art, the unmanned aerial vehicle in this embodiment also includes necessary constituent hardware such as a graphic transmission device for sending the panoramic video to a display device, a wireless transmission device (such as an RC controller) for receiving and sending control execution.

The display device is used to display the picture of the spherical panoramic video and the attitude information (such as the flight direction or the flight direction and the coordinates) of the unmanned aerial vehicle according to the viewing angle display information. Specifically, the viewing angle display information may be generated on the display device according to the operation of the user. For example, when the display device is a computer, the viewing angle display information may be obtained by operating the mouse, and when the visual display device is VR glasses, the viewing angle display information may be obtained by the head movement of the user detected by VR glasses. The viewing angle display information may also be generated by the user through operating the remote control device. For example, when the remote control device is a rocker, the viewing angle display information is obtained by detecting the moving direction of the rocker.

The remote control device is used to send the flight control command of the user to the flight control device of the unmanned aerial vehicle, and then control the unmanned aerial vehicle to execute the flight control command. The remote control device includes but is not limited to a mouse, a joystick or a somatosensory remote controller, and the flight control command include but is not limited to the flight direction and the flight speed.

In the control system for the unmanned aerial vehicle in this embodiment, the display device is VR glasses that can detect the movement of the head, and the remote control device is a somatosensory remote controller that can detect the movement of hands in three-dimensional space.

In other alternative schemes, the remote control device and the display device may also be integrally designed. For example, the VR helmet may be provided with a flight control mode and a viewing mode. In the flight control mode, the flight direction of the unmanned aerial vehicle can be controlled by swinging the head; while in the viewing mode, the viewing angle display information can be obtained by swinging the head and displayed on the VR helmet synchronously.

What described above are only the preferred embodiments of the present invention, and they are not intended to limit the present invention. Any modification, equivalent substitution and improvement made within the spirit and principle of the present invention shall be included in the scope claimed in the present invention.

1. A control method for an unmanned aerial vehicle, comprising:
S1: acquiring an attitude of an unmanned aerial vehicle and displaying the attitude;
S2: acquiring a video around the unmanned aerial vehicle corresponding to the attitude;
S3: displaying the video according to a viewing angle display information;
S4: controlling the unmanned aerial vehicle to fly according to a flight control command, and returning to step S1;
wherein the video comprises spherical panoramic video, annular panoramic video or wide-angle video.

2. The control method for an unmanned aerial vehicle according to claim 1, wherein the step S1 comprises:
S11: acquiring an attitude of the unmanned aerial vehicle in a world coordinate system;
S12: constructing a display interface coordinate system;
S13: converting the attitude of the unmanned aerial vehicle in the world coordinate system into an attitude in the display interface coordinate system and displaying the attitude in the display interface coordinate system.

3. The control method for an unmanned aerial vehicle according to claim 2, wherein the step S3 comprises:
S31: acquiring a viewing angle display information in the display interface coordinate system;
S32: converting the viewing angle display information in the display interface coordinate system into a viewing angle display information in the world coordinate system;
S33: displaying the video according to the viewing angle display information in the world coordinate system

4. The control method for an unmanned aerial vehicle according to claim 1, wherein the attitude of the unmanned aerial vehicle comprises a flight direction and/or spatial coordinates of the unmanned aerial vehicle.

5. The control method for an unmanned aerial vehicle according to claim 1, wherein the viewing angle display information comprises a display direction, or comprises the display direction and a size of viewing angle.

6. The control method for an unmanned aerial vehicle according to claim 1, wherein the panoramic video is a video processed by stabilizing technology.

7. A control system for an unmanned aerial vehicle, comprising an unmanned aerial vehicle, a display device and a remote control device;
wherein the unmanned aerial vehicle comprises a flight control device and a photographing device, the flight control device being configured to acquire an attitude information of the unmanned aerial vehicle, and the photographing device being configured to acquire a video around the unmanned aerial vehicle;
the display device is configured to display the attitude of the unmanned aerial vehicle and display the video according to a viewing angle display information;
the remote control device is configured to send a flight control command to the flight control device;
wherein the video comprises spherical panoramic video, annular panoramic video or wide-angle video.

8. The control system for an unmanned aerial vehicle according to claim 7, wherein the photographing device comprises at least two lenses, and fields of view of adjacent lenses among the at least two lenses overlap each other to form a 360-degree panoramic viewing angle around the unmanned aerial vehicle.

9. The control system for an unmanned aerial vehicle according to claim 7, wherein the photographing device is a panoramic camera.

10. The control system for an unmanned aerial vehicle according to claim 7, wherein the display device is VR glasses, and the VR glasses are configured to obtain the viewing angle display information.

11. The control system for an unmanned aerial vehicle according to claim 7, wherein the remote control device is a somatosensory remote controller.
